(19) United States
(12) Patent Application Publication
(10) Pub. No.: US 2010/0124277 A1
(43) Pub. Date: May 20, 2010

(54) Video encoding with even bit stream

(75) Inventors: Hao Wang, Beijing (CN); Song Qiu, Beijing (CN); Jinghui Lu, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/475,524

(22) Filed: May 31, 2009

(30) Foreign Application Priority Data
Nov. 14, 2008 (CN) 200810226587.2

(51) Int. Cl. H04N 7/12

(52) U.S. Cl. 375/240.13; 375/E07.076

(57) ABSTRACT

A video encoding technique producing an even output bit stream is disclosed. According to one aspect of the present invention, an instantaneous peak of the output bit stream is greatly reduced by dividing one image frame into a key area and a background area, then inter-frame encoding the key area and the background area in different frames respectively. In other words, a whole bit stream of one I frame in the prior art is distributed into two or more image frames in the present invention.

### BACKGROUND OF THE INVENTION

1. Field of the Invention

The present invention relates to the area of video compression, more particularly to video encoding techniques with stable bit stream.

2. Description of Related Art

There are three types of frames or pictures used in video compression: I frames, P frames, and B frames. I frames are coded without reference to any frames except themselves. P frames are coded with reference to preceding frames. B-frames are coded with reference to preceding and following frames of a current frame. I frames is ‘Intra-frame encoded pictures’, and the B frames and the P frames are ‘inter-frame encoded pictures’.

I frame is a fully-specified picture like a conventional static image and has a lower video compression rate. P frame holds only changes in a current image from a previous frame. The encoder does not need to store the unchanging background pixels in the P frame, so saving space. B frame saves even more space by using differences between the current frame and both the preceding and following frames to specify its content. I frame typically requires tens times or even several tens times bit steams to be encoded than P frame or the B frame. Hence, an average bit rate is reduced by increasing interval of I frame usually when the video monitor is realized based on a narrow-channel (e.g., wireless network or ADSL uplink channel).

FIG. 1 is a diagram showing a bit stream of video frames encoded in a conventional ways. Referring to FIG. 1, a peak of the bit stream of an I frame is about 90000, but a peak of the bit stream of the B frame or P frame is less than 10000. The uneven bit streams with large fluctuation range may bring strong instantaneous impact to the network transmission, even arise problems such as network packet loss and transmission error and etc.

Thus, improved techniques for a video encoding method with more even bit stream are desired to overcome the above disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to a video encoding technique with. An output bit stream obtained using the video encoding technique is more even than that obtained using a conventional way. According to one aspect of the present invention, an instantaneous peak of the output bit stream is greatly reduced by dividing one image frame into a key area and a background area, then inter-frame encoding the key area and the background area in different frames respectively. In other words, a whole bit stream of one I frame in the prior art is distributed into two or more image frames in the present invention.

One of the features, benefits and advantages in the present invention is to provide techniques for

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a diagram showing a bit stream of video frames encoded in a conventional ways;

FIG. 2 is a flow chart showing a video coding method according to one embodiment of the present invention;

FIG. 3 is an exemplary diagram showing a bit stream of video frames encoded in the video coding method according to one embodiment of the present invention;

FIG. 4 is another exemplary diagram showing the bit stream of video frames encoded in the video coding method according to one embodiment of the present invention; and

FIG. 5 is a process or flowchart showing the video coding method according to another embodiment of the present invention.

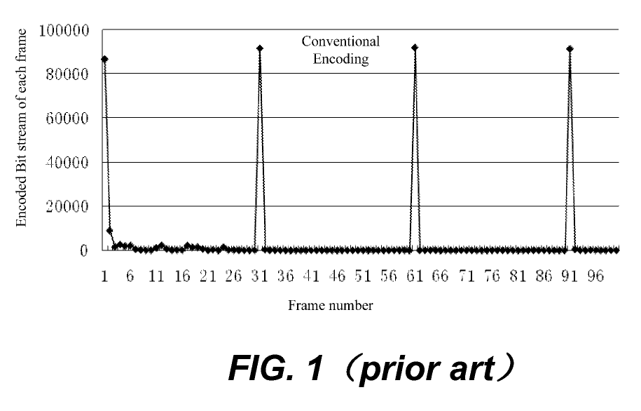

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

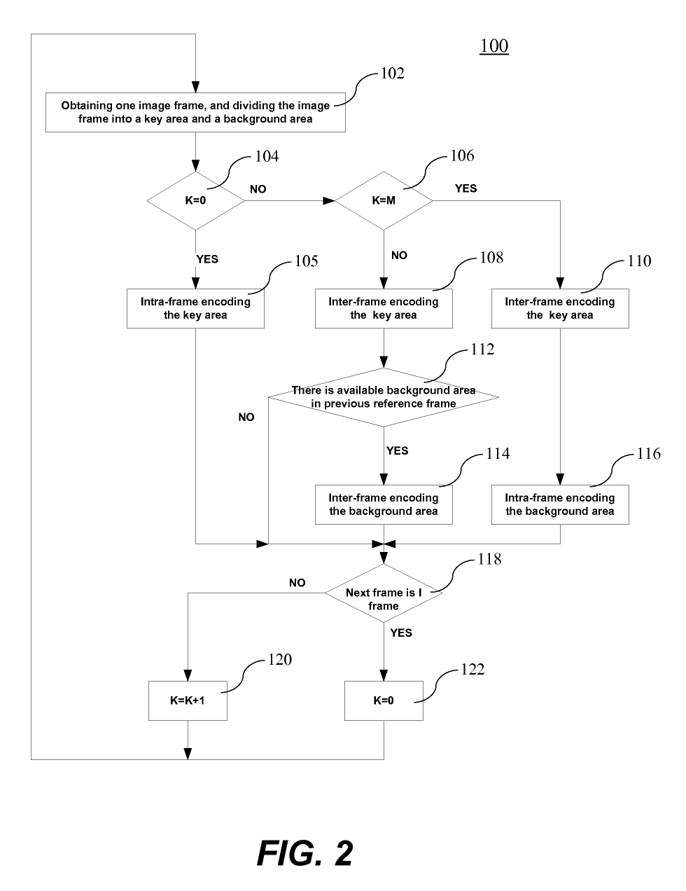

Embodiments of the present invention are discussed herein with reference to FIGS. 2-5. However, those skilled in the art will readily appreciate that the detailed description given herein with respect to these figures is for explanatory purposes only as the invention extends beyond these limited embodiments.

An improved video coding method is provided according to one embodiment of the present invention. An output bit stream obtained by using the video coding method of the present invention is more even than that obtained by using a conventional way. In the present invention, an instantaneous peak of the output bit stream is greatly reduced by dividing one image frame into a key area and a background area and inter-frame encoding the key area and the background area in different frames respectively. In other words, a whole bit stream of one I frame in the prior art is distributed into two or more image frames in the present invention.

FIG. 2 is a flow chart showing the video coding method according to one embodiment of the present invention. The process 100 begins at 102, where one image frame captured by an image capturing device (e.g. a monitoring camera) is divided into the key area and the background area. Each image frame may be divided into the key area required to be focused (e.g. road surface areas in a traffic monitoring system) and the background area not required to be focused (e.g. trees and shops at the roadside in the traffic monitoring system) for monitoring purpose. In one embodiment, the key area and the background area are configured manually by a human operator. For example, the human operator may select artificially what area of the monitor image is the key area and what area of the monitor image is the background area by drawing windows over the monitoring image. In another embodiment, the key area and the back ground area are configured automatically according to an intellectual detection method. For example, a method for detecting and tracking motion objects is used to determine areas with high moving frequency as the key area and areas with low moving frequency as the background area. In another embodiment, the above two ways may be associated to determine the key area and the back ground area in the image frame.

A variable K is provided to indicate a frame number between a current image frame and a latest I frame. For example, K=0 indicates that the frame number between the current image frame and the latest I frame image is zero, namely the current image frame should be encoded as the I frame. Generally, an encoder may be configured to insert one I frame every N image frames, wherein N is a predetermined integer (e.g. 30 or 40). So, a next image frame should be encoded as the I frame if K=N−1. The process 100 proceeds at 104, where to determine whether K=0. If yes, that means that the current image frame should be encoded as the I frame, the process 100 is taken to 105; otherwise, that means that the current image frame should not be encoded as the I frame, the process 100 is taken to 106.

Another predetermined integer M less than N is configured to indicate where the intra-frame coding to the background area should be processed. The value of M is relative to the size of the key area. If the size of the key area is larger, a larger M should be determined to efficiently distribute the peak of the bit stream. In one embodiment, M may be equal to about a half of N. At 106, it is further determined whether K=M. If yes, that means that the intra-frame coding to the background area should be processed at the current image frame, the process 100 is taken to 110; otherwise, that means that the intra-frame coding to the background area should not be processed at the current image frame, the process 100 is taken to 108.

At 105, the key area of the current image frame is intra-frame encoded without reference to any frames except themselves and the background area of the current image frame is skipped. Thus, an output bit stream of the current image frame is formed. Subsequently, the process 100 proceeds at 118.

At 108, the key area of the current image frame is inter-frame encoded with reference to a preceding frame or/and a following frame. Then, it is determined whether there is available background area in previous reference frame at 112. If yes, the background area of the current image frame is also inter-frame encoded at 114; otherwise, the background area of the current image frame is skipped. Thus, the output bit stream of the current image frame is formed. Subsequently, the process 100 proceeds at 118.

At 110, the key area of the current image frame is inter-frame encoded with reference to the preceding frame or/and the following frame. Then, the background area of the current image frame is intra-frame encoded without reference to any frames except themselves at 116. Thus, the output bit stream of the current image frame is formed. Subsequently, the process 100 proceeds at 118.

At 118, whether the next image frame should be coded as the I frame is determined. If yes, K is set to equal to 0 at 122; otherwise, K is added by 1 at 120. Then, the process 100 returns to 102 to proceed until all image frames are encoded. In one embodiment, if K=N−1, it concludes that the next image frame should be coded as the I frame; otherwise, it concludes that the next image frame should not be coded as the I frame.

In order to decode the encoded bit stream, some special parameters including parameters in relation to the key area and parameters in relation to the background area are added into a head of the current image frame in addition to some conventional parameters in the prior art. The parameters in relation to the key area comprise a number of sensitive areas, and a position and size parameter of each sensitive area. It should is noted that the key area comprises all sensitive areas. Other areas except for the sensitive areas belong to the background area. The parameters in relation to the background area comprise a parameter indicating whether the background area is skipped and a parameter indicating that the background area is inter-frame encoded or intra-frame encoded when the background area is not skipped.

In addition to some conventional I frame parameters, the head of the current image frame when K=0 further comprises:

```
{ sensitive area number: 1;
  sensitive area position:
    coordinate of top left corner: (x,y) = (1, 80);
    coordinate of lower right corner: (x,y) = (352, 230);
  background area: skip mode}.
```

If the sensitive area number is larger than 1 in other examples, the position and size parameter of each sensitive area should be included.

In addition to some conventional P or B frame parameters, the head of the current image frame when K=M further comprises:

```
{ sensitive area number: 1;
  sensitive area position:
    coordinate of top left corner: (x,y) = (1, 80);
    coordinate of lower right corner: (x,y) = (352, 230);
  background area: non-skip mode, intra-frame encoding}.
```

In addition to some conventional P or B frame parameters, the head of the current image frame when K is from 1 to M−1 or from M+1 to N−1 further comprises:

```
{ sensitive area number: 1;
  sensitive area position:
    coordinate of top left corner: (x,y) = (1, 80);
    coordinate of lower right corner: (x,y) = (352, 230);
  background area: non-skip mode, inter-frame encoding} or
{ sensitive area number: 1;
  sensitive area position:
    coordinate of top left corner: (x,y) = (1, 80);
    coordinate of lower right corner: (x,y) = (352, 230);
  background area: skip mode}.
```

It can be seen that the first I frame and the following M−1 image frames have no the background area when the video monitoring system just begins since no available background area can be referred before the first time to intra-frame encode the background area. However, the overall visual effect in the present invention has no obvious changes.

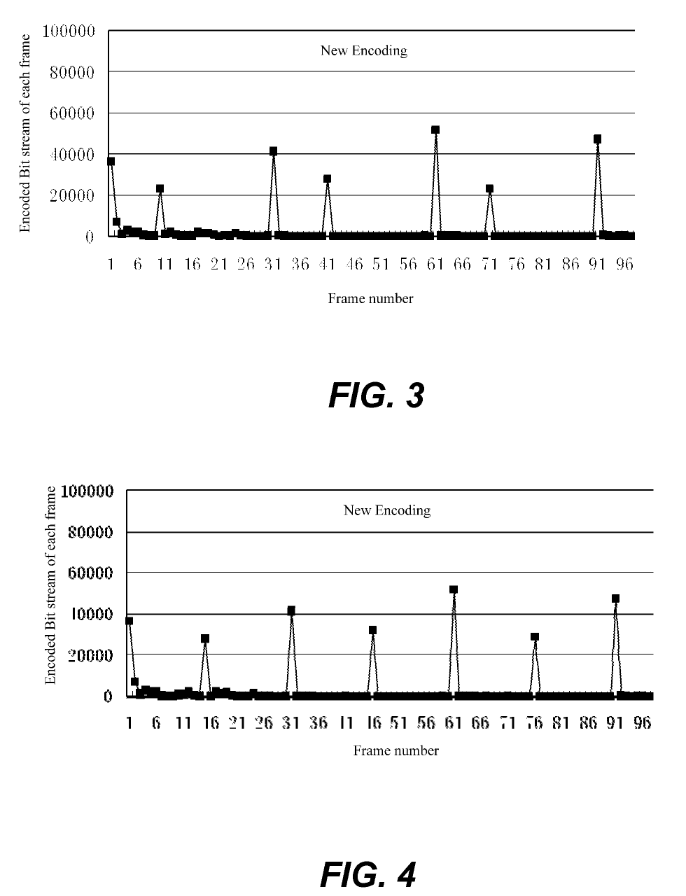

FIG. 3 is an exemplary diagram showing the bit stream of video frames encoded in the video coding method of the present invention, wherein N=30 and M=10. FIG. 4 is another exemplary diagram showing the bit stream of video frames encoded in the video coding method of the present invention, wherein N=30 and M=15.

Referring to FIG. 3, the bit number of the I frame is reduced to about 40000-50000 and far less than that of the I frame coded in conventional method. The bit number comes to another larger peak being about 20000-30000 at the tenth frame after the I frame. Referring to FIG. 4, the bit number of the I frame is reduced to about 40000-50000 and far less than that of the I frame coded in conventional method. The bit number comes to another larger peak being about 20000-30000 at the 14th frame after the I frame. It can be seen that a fluctuation range of the bit stream is restricted efficiently.

As described above, the bit stream of the I frame in the prior art is distributed into two image frames by inter-frame encoding the key area when K=0 and inter-frame encoding the background area when K=M. Thus, the instantaneous peak of the output bit stream is greatly reduced.

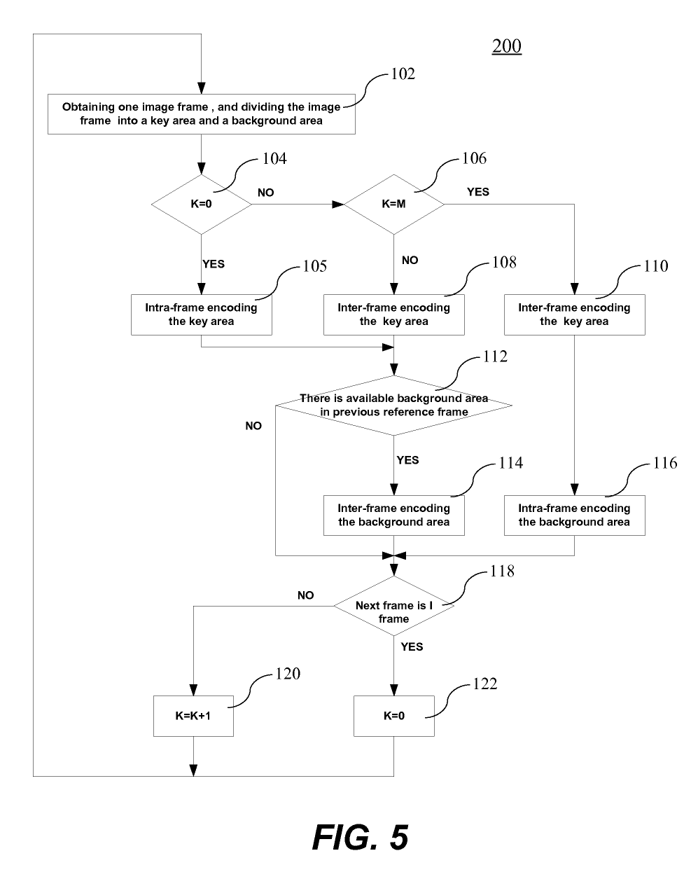

FIG. 5 is a flow chart showing the video coding method 200 according to another embodiment of the present invention. The video coding method shown in FIG. 5 is identical with the video coding method shown in FIG. 2 except that the process 200 is taken to 112 after 105. The parameter indicating that the background area is inter-frame encoded or intra-frame encoded when the background area is not skipped should be added into the head of the image frame when K=0. Comparing with the video coding method shown in FIG. 2, the number of the bit stream is increased a little, and a delay problem about the background area is improved efficiently.

When the image frame is reconstructed in a decoder, if the background area in the head of the image frame is marked as “skip-mode”, the following operations is preformed: directly copying the background area of previous decoded image frame as the background area of the current decoded image frame if the previous decoded image frame has available background area; setting all pixel values of the background area of the current decoded image frame to a predetermined value (e.g., 128 or 0).

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for encoding image frame sequence, each image frame of the image frame sequence being divided into a key area and a background area, the method comprising:
intra-frame encoding the key area of a first image frame, and inter-frame encoding or skipping the background area of the first image frame;
intra-frame encoding the background area of a second image frame and inter-frame encoding the key area of the second image frame, a plurality of third image frames being included between the first image frame and the second image frame; and
inter-frame encoding the key area of the third image frame, and inter-frame encoding or skipping the background area of the third image frame.

2. The method according to claim 1, wherein one image frame is selected from the image frame sequence as the first image frame every N image frames, and one image frame is selected from image frame sequence as the second image frame every N image frames, and wherein N is a predetermined integer.

3. The method according to claim 1, wherein parameters in relation to the key area and parameters in relation to the background area are added into a head of the image frame.

4. The method according to claim 3, wherein the parameters in relation to the key area comprise a number of sensitive areas, and a position and size parameter of each sensitive area.

5. The method according to claim 3, wherein the parameters in relation to the background area comprise a parameter indicating whether the background area is skipped and a parameter indicating that the background area is inter-frame encoded or intra-frame encoded when the background area is not skipped.

6. The method according to claim 1, wherein the inter-frame encoding or skipping the background area of the first image frame comprises:
inter-frame encoding the background area of the first image frame if there is available background area in previous reference frame;
skipping the background area of the first image frame if there is no available background area in previous reference frame.

7. The method according to claim 1, wherein the inter-frame encoding or skipping the background area of the third image frame comprises:
inter-frame encoding the background area of the third image frame if there is available background area in previous reference frame; and
skipping the background area of the third image frame if there is no available background area in previous reference frame.

8. The method according to claim 1, wherein the image frame is divided into the key area and the background area by a human operator or an intellectual motion detection method.

9. A video encoding method, comprising:
dividing each image frame of a image frame sequence into a key area and a background area;
selecting a first image frame every N image frames, intra-frame encoding the key area of the first image frame;
selecting a second image frame every N image frames, intra-frame encoding the background area of the second image frame; and wherein
the first image frame is different from the second image frame, and N is a predetermined integer.

10. The video encoding method according to claim 9, further comprising:
inter-frame encoding the background area of the first image frame if there is available background area in previous reference frame;
skipping the background area of the first image frame if there is no available background area in previous reference frame.

11. The video encoding method according to claim 9, further comprising:
inter-frame encoding the key area of the second image frame.

12. The video encoding method according to claim 9, wherein a plurality of third image frames is included between the first image frame and the second image frame, and wherein the video encoding method further comprises:
inter-frame encoding the key area of the third image frame;
inter-frame encoding the background area of the third image frame if there is available background area in previous reference frame; and
skipping the background area of the third image frame if there is no available background area in previous reference frame.

13. The video encoding method according to claim 9, wherein the image frame is divided into the key area and the background area by a human operator or an intellectual motion detection method.
